(19) United States
(12) Patent Application Publication
(10) Pub. No.: US 2005/0177265 A1
(43) Pub. Date: Aug. 11, 2005

(54) Transfer line

(76) Inventor: Burkhart Grob, Bad Worishofen (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/615,179

(22) Filed: Jul. 9, 2003

(30) Foreign Application Priority Data
Jul. 9, 2002 (DE) 102 31 017.3

(51) Int. Cl. G06F 19/00

(52) U.S. Cl. 700/112; 29/563; 700/159

(57) ABSTRACT

The invention refers to a transfer line which comprises several stations serving for the machining of workpieces, and the stations being connected to each other by a conveying line on which the workpieces, respectively the workpiece carriers carrying the workpieces, are conveyed from station to station. The invention is characterised by the fact that at least one of the stations is designed inherent stiffly, preferably as hook machine, and the station is equipped with an autonomously working station control which controls the working processes of the station.

### BACKGROUND OF THE INVENTION

The invention refers to a transfer line comprising several stations which serve for machining workpieces, and where the stations are connected to each other by a conveying line. The workpieces are conveyed on the conveying line from station to station. The workpieces can be conveyed unit load-like or they are, on the other hand, conveyed mounted on workpiece carriers (device carriages, pallets, slabs and so on).

In the state of the art transfer lines are known sufficiently. Commonly transfer lines comprise a plurality of machining stations in a sequence one after the after (for example lathes, drills, grinders or measuring machines). As a rule, these machines are designed as special machines, that is they are especially designed and optimised for their respective machining task. The more specialised they are designed for their special task the larger the productivity of the installation, however, simultaneously the flexibility decreases, for example for different production objects. It is known to convey the workpieces clocked, however, the slowest machining step giving the clocking frequency.

From the DE 196 26 581 A1 a transfer line with machining stations is known. The solution presented there refers to a transfer line with devices for conveying the workpieces along center columns, lateral columns being provided at the sides of the center columns, on which the machining units are supported traveling, and with supply devices for the machining stations. The solution suggested there shall remove the problem that the inherent supply lines of the respective machining stations do not impede the transport of the workpieces on their way to the control table. According to the solution proposed there all supply lines should not, as before, be arranged above or below the side units but exclusively inside or in the region of the center column. In this known solution it is also proposed that for securing of a module-like construction as perfect as possible of each clocking unit, if possible, independently from the other clocking units, at least in the main lines for hydraulic, lubrication, pneumatic and so on, if possible, however, also in the cable ducts and the current rails, stop devices or plug-in connections should be arranged. In the solution according to DE 196 26 581 A1 the concept to provide the individual machining stations as a plurality of machining stations arranged one behind the other is not given up here. Thus the disadvantages described before concerning the productivity and flexibility still exist also in the solution suggested here.

From the citation DE 198 49 374 A1 a production system for producing workpieces is known. The production system suggested here is supposed to be characterised by the fact that the production system itself is designed modularly, each respective module comprising: a machine, two shifting tables, the machine being arranged between the shifting tables, and a discharge table which connects the shifting tables with the machine. In this solution, either, no suggestions are cited which lead away from the specialising of the individual machining stations.

From the citation DE 199 48 189 A1 a flexible production system is known which is characterised by the fact that different types of machine tools are provided multiply redundantly and before each machine tool a workpiece store is located, the numeric control of the conveying system being able to define the level of the workpiece store and depending from the level the machined workpieces being guided into the workpiece store of a certain machine. For the construction of such a production system, too, very different and specialised machining devices are necessary which increase the expenses of a production line and which can be attributed to the production lines already described before which work clocked, the slowest machining step defining the clocking frequency.

As the transfer line is designed as a special machine for the respective application, also the construction of each station is extremely different. The consequence is that also each individual station is planned as special machine and also the installation of the whole transfer line in the production site is correspondingly expensive. Also the control of the transfer line is planned for this single special application and is also comparatively inflexible for the case changes have to be carried out.

### BRIEF SUMMARY OF THE INVENTION

It is an object of the present invention to improve transfer lines, as described in the beginning, in such a way that they become more economic and flexible.

In order to solve this problem the invention comes from a transfer line as described in the beginning and suggests that at least one of the stations is designed inherent stiff and the station is equipped with an autonomously working station control which controls the working procedures of the station.

The invention proposes a complete new procedure in the construction of transfer lines. Instead of realising expensive special machines specialised for a particular case, a station is proposed which is preferably designed module-like and self-sufficient. The self-sufficiency, respectively the autonomy, of the stations is achieved, among others, by a station control which monitors only the work processes for the station itself and, if necessary, the conveying in and out of the workpiece. As furthermore an inherent stiff station is proposed, which should basically be premounted in the plant as a hook machine and be delivered ready to run into the production site, also the effort for the mounting is reduced clearly, because the machines are delivered already tested for functioning, concerning the mechanic as well as also the control. This means that the machining station is finished as a completely independent machine and can then be shipped in order to bring it to its future location of application. When the machining device has been finished it can be hung onto the hook of a hoist and be loaded, respectively unloaded. A simple exchange of the station is given in the same way. The module-like design does not exclude an inherent stiff, self-supporting construction. On the contrary, the combined advantages of the inherent stiffness and of the modular construction are used in an embodiment of the invention. According to the proposal of the invention an expensive mounting of the station itself in the station site has been abandoned quite consciously in order to reduce the mounting times of the transfer line correspondingly which adds to the lowering of expenses.

The concept provides furthermore the ability to produce the individual stations as a standard machine on a large-scale manufacture. Eventually the necessary machining in a transfer line are always very similar, that means that the workpiece is clamped, positioned relatively to the machining unit, as a rule to a tool spindle, and has to be machined by it (for example metal cutting). However, if the mounting for the station is standardised, in particular an inherent itself stiff station is realised, other conditions do not have to be taken so much into consideration, because it is clear from the beginning which basic demands (which may be quite high in comparison) have to be made on the respective station which is produced as a serial machine. However, if serial machines which are particularly adjusted concerning the control technique can be successfully used for complex, usually highly individual works, the effort for the production of such a transfer line is clearly reduced because the constructive effort decreases. The effort for programme technique, respectively control technique, passes away from the transfer line control to the correspondingly more intelligent station control. However, an appropriate schematising is also possible there, because certain work sequences are carried out again and again in the station control and actually the real machining differs from station to station. The steps, conveying in the workpiece, positioning the workpiece, conveying out the workpiece and release it again remain the same as a rule in all stations.

Surprisingly the invention reaches not only an advantage in the mounting of a corresponding transfer line. As the concept of the transfer line is provided in the way that the transfer line comprises as much stations as possible which work autonomously, that is self-sufficiently, also an alteration of the transfer line is possible in the simplest way. This results in decisive advantages for the user. In the case that, for example, a station is faulty or the transfer line has to be elongated or altered simply the concerned station module is removed and substituted by a correspondingly suitable one or a correspondingly suitable station is added to the transfer line. Because no transfer line control is provided which monitors and dominates the complete machining process of the transfer line, but it is decentralised distributed to the respective station controls a corresponding alteration is possible even for the user in a simple and thus also economic manner.

In a preferred variant of the invention it is proposed that each station is equipped with one transfer drive each, respectively one transfer drive is assigned to each station. Besides the machining of a workpiece also the conveying of the workpiece between the individual stations in the transfer line is very important. In order to achieve also here a high degree of autonomy each station takes care independently of the transfer drive of the workpiece. For that reason it may be provided that each station has its own corresponding transfer drive or, for example, when the transfer drive is arranged on the conveying line, which can be arranged actually separately from the machining station, that a transfer drive is assigned to each station. Eventually here the station control comprises, if necessary, not only the functionalities of the stations alone but also simultaneously it takes care of a conveying in and out of the workpieces on the conveying line as smoothly as possible.

Therefore the result is that the transfer drive provides a conveying of the workpiece on the conveying line, no difference being made between conveying in or out line, this may be decided according a basic transfer line concept. For example, in long conveying lines which connect two stations the responsibilities for this conveying line can be divided between the two arranged stations. This is possible without any problems by means of a corresponding formation of blocs.

Conveniently the workpieces are mounted on workpiece carriers. The use of workpiece carriers allows comparatively simple handling of the workpieces in the transfer line. For that different concepts are known. For example, a device carriage, a pallet, a slab or the like may be provided as workpiece carrier. However, the invention can be used in the same way in arrangements where the workpiece is conveyed directly on the conveying line and the use of a workpiece carrier is abandoned.

In a preferred embodiment of the invention it is provided that the transfer drives of the different stations effect a movement of the workpiece, respectively the workpiece carrier, which has to be conveyed, independently from each other. Therefore a decoupling of the respective transfer movements on the conveying lines is achieved. The flexibility, but also the productivity, of a transfer line designed like that according to the invention is improved. In case of a disturbance not the complete transfer line is stopped, but the workpieces are piled up in front of the disturbed machining station; the workpieces which have to be machined, the other machining stations still stay in work. The consequence is that the transfer line connecting two stations serves as a buffer store for workpieces, respectively workpiece carriers.

It is convenient, if a draw-in, respectively a push-out, device is provided on the station which serves in particular for the positioning of the workpiece, respectively the workpiece carrier, in the station. It is, for example, possible, that the workpiece, respectively the workpiece mounted on the workpiece carrier, is clamped in the machining station on a special work table and thus a correspondingly exact positioning is needed beforehand. Therefore it is convenient to provide in this region a draw-in device which works accurately. The draw-in device can take over simultaneously, after finishing the machining, the push-out function and convey away the workpiece/workpiece carrier into the region of the conveying line. Conveniently a storing of the workpiece carrier on slide strips is suggested in order to achieve a positioning accuracy as high as possible. If the storage is carried out on rollers a certain risk of shifting exists for the put-in workpiece, if the rollers are supported eccentric, even if the drive has stopped which may lead to corresponding inaccuracies in the positioning.

Another advantage of the invention lies in the fact that the conveying line is connected directly with the frame of the station. The transfer line is planned in such a way that additional frames for the conveying line can be avoided which, of course, favours the effort and the access of a conveying line accordingly. As the frame has already a high stability, because of the demanded inherent stiffness of the station, it is possible without any problems to attach also the conveying line directly to it. This is accompanied by a correspondingly low effort for the mounting because adequate mounting aids can just be provided on the frame.

It is convenient if the conveying line is equipped with driven rollers or frictional rollers or the like. This concept has already proven to be successful for the conveying of workpiece carriers, respectively of workpieces. They also allow a movement of the workpiece carrier over a long distance with comparatively little effort, also a sectional control of the rollers being possible. Alternatively, it is possible to provide corresponding tape or spindle drives.

The station control, which, as a rule, acts autonomously, has to fulfil a plurality of different tasks. The station control can, of course, in the sense of the invention, receive additional information from the transfer line control, if it concerns, for example, the particular machining conditions, these may be given from a central data register of the transfer line control to the respective station control. However, it is unimportant for the transfer line control how the individual machining step and also the conveying of the individual workpiece carriers is carried out locally. This is preferably integrated in the station control. Therefore it is suggested that the station control also monitors the incoming conveying. This serves for informing the station when a corresponding additional machining has to be carried out.

Furthermore it is convenient if the station control interrupts the machining of workpieces when finished workpieces cannot be conveyed out to the outgoing conveying line. If a jam occurs in the outgoing conveying lines, naturally, a following workpiece cannot be machined. Of course this occurs also when, for example, the piling-up capacity of the following conveying line has run out and the finished workpiece cannot be conveyed out. In this case the control has to recognise that and postpone the further conveying-in of already approached workpieces until the station is clear again. Therefore it is enough to make sure that the finished workpiece has been conveyed out. An additional monitoring of the following conveying line, which is also the conveying in line for the next station, is not necessary in this case.

However, on the other hand, interfaces are defined which are conform with the basic modular idea of the invention and also are in accordance with the advantages mentioned above concerning flexibility.

In a preferred embodiment of the invention it is provided that the station has a frame which comprises the machining unit and, if necessary, a workpiece carriage, respectively workpiece machining table. The station, which is designed conveniently modular has all elements in order to basically carry out a machining. Naturally, it is possible to change a detail for more complex machining in this serial machine in order to make additional functions possible, however, the concept of the use of a station produced in a series is tried to be maintained consequently in order to use as completely as possible the advantages described in the beginning. Therefore the consequence is that, besides the sufficiently stable designed, inherent stiff frame, the station has also the other features which are necessary for a machining of the workpiece.

In the preferred variant it is provided that the frame is one-part. Naturally it is possible to compose the frame from several parts and to create a one-part frame. However, the intention is that the frame has not been dismantled again into its parts in order to carry out an alteration or a shifting of the station.

An essential advantage of a variant of the invention lies in the fact that the station is designed module-like and is able to function, respectively be transported, independently. These features have been described already in other passages. Just because it is the intention to design the station on a broader range of use, but not too highly specialised, for different applications and still to be able by means of a special control to carry out also individually complex machining, it is achieved that the station itself can be constructed module-like, for example, when a corresponding repair measurement has to be carried out. To put it simply, here only the station has to be removed from the transfer line, that is to dismantle the respective conveying lines, respectively disconnect them, to remove the station itself from the base and to block the necessary supply conducts. Then the station may be, for example, be lifted by a crane on a hook and transported out. If the station can work independently its function can be tested, respectively used, individually. Therefore the flexibility of the transfer line according to the invention is improved enormously.

In a preferred variant of the invention it is provided, that the workpiece carriers, respectively the workpieces, have data carriers which carry information about the workpiece, respectively the machining which has to be carried out on the workpiece, and the station control receives these data from a reader which reads the data carrier. Basically the transfer line according to the invention also allows a flexible production. However, the consequence is that maybe in a flexible production the application of certain machining stations is not necessary anymore. But because the use of a complex transfer line control is abandoned, this is essentially decentralised distributed to the different station controls, naturally the respective station control has to be informed which workpiece, respectively which machining on the workpiece, has to be carried out now. This is achieved in a simple way by the fact that the workpiece, respectively the workpiece carrier, is provided with a data carrier on which the respective information is stored. For that different variants and concepts are known. It may be transponder or bar code applications, or also applications where a data chip is read. The machining information may here follow from the station control or, on the other hand, the transfer line control stores corresponding data banks which delivers them, upon demand, to the respective station and its station control.

Although the invention has been described by exact examples which are illustrated in the most extensive detail it is pointed out that this serves only for illustration and that the invention is not necessarily limited to it because alternative embodiments and methods become clear for experts in view of the disclosure. Accordingly changes can be considered which can be made without departing from the contents of the described invention.

1. Transfer line comprising several stations which serve for machining workpieces, the stations being connected to each other by a conveying line on which the workpieces, respectively the workpiece carriers carrying the workpieces, are conveyed from station to station, characterised in that at least one of the stations is designed inherent stiff in itself and the station is equipped with an autonomously working station control which controls the working procedures of the station.

2. Transfer line according to claim 1, characterised in that at least one of the stations is designed as a hook machine which is premounted in the plant and can be delivered ready to run.

3. Transfer line according to claim 1, characterised in that each station is provided with one transfer drive each.

4. Transfer line according to claim 1, characterised in that one transfer drive is assigned to each station.

5. Transfer line according to claim 1, characterised in that the station control monitors and controls, besides special working procedures of the station, schematic-working sequences.

6. Transfer line according to claim 1, characterised in that the station control is designed as an intelligent station control.

7. Transfer line according to claim 1, characterised in that the transfer drive provides conveying of the workpiece on the conveying line.

8. Transfer line according to claim 1, characterised in that the workpieces are mounted on workpiece carriers.

9. Transfer line according to claim 1, characterised in that the transfer drives of the different stations are designed in such a way that they effect independently from each other a movement of each workpiece which has to be conveyed, respectively each workpiece carrier.

10. Transfer line according to claim 1, characterized in that at the station a draw-in, respectively a push-out, device is provided.

11. Transfer line according to claim 1, characterised in that the draw-in and push-out device serves in particular for positioning of the workpiece, respectively the workpiece carrier, in the station.

12. Transfer line according to claim 1, characterised in that slide strips are provided for the support of the workpiece carrier.

13. Transfer line according to claim 1, characterised in that the draw-in, respectively push-out, device also serves as transfer drive.

14. Transfer line according to claim 1, characterized in that the conveying line which connects two stations serves as a buffer store for workpieces, respectively workpiece carriers.

15. Transfer line according to claim 1, characterised in that the conveying line is connected directly to the frame of the station.

16. Transfer line according to claim 1, characterised in that the conveying line is equipped with driven rollers or frictional rollers or the like.

17. Transfer line according to claim 1, characterised in that the station control also monitors the incoming conveying line.

18. Transfer line according to claim 1, characterised in that the station control interrupts the machining of workpieces when finished workpieces cannot be conveyed to the outgoing conveying line.

19. Transfer line according to claim 1, characterised in that the station control does not feed a new workpiece which has to be machined before the station is free.

20. Transfer line according to claim 1, characterised in that the station control monitors that finished workpieces will be actually conveyed out.

21. Transfer line according to claim 1, characterised in that the station has a frame, preferably a one-part frame, which holds the machining unit and, if necessary, a workpiece slide, respectively workpiece machining table.

22. Transfer line according to claim 1, characterised in that the station is designed module-like and is able to function independently.

23. Transfer line according to claim 1, characterised in that the station is designed module-like or can be transported.

24. Transfer line according to claim 1, characterised in that the workpiece carriers or the workpieces have data carriers which carry information about the workpiece, respectively the machining which has to be carried out on the workpiece, and the station control receives these data from a reader which reads the data carrier.

25. Transfer line according to claim 1, characterised in that the station is arranged as a series machine for different uses and the adjustment for the respective machining function is given by the station control.
